(19) United States
(12) Patent Application Publication
(10) Pub. No.: US 2018/0299145 A1
(43) Pub. Date: Oct. 18, 2018

(54) SPILL RESISTANT REFILLABLE MOISTURE ABSORBER

(71) Applicant: W.M. Barr & Company, Inc., Memphis, TN (US)

(72) Inventors: Wendy Groover, Germantown, TN (US); Barry Wood, Memphis, TN (US); Charles L. Hawes, Memphis, TN (US); Dennis Earl Shireman, Marion, AR (US); Matthew Michael Petkus, Memphis, TN (US); Victor Nordlund, Memphis, TN (US); Douglas R. Pemberton, Timonium, MD (US); Joshua Barnes, Baltimore, MD (US); Kevin Barnes, Baltimore, MD (US); Shannon Wheeler, Arnold, MD (US)

(21) Appl. No.: 15/655,221

(22) Filed: Jul. 20, 2017

Related U.S. Application Data
(60) Provisional application No. 62/484,950, filed on Apr. 13, 2017.

(51) Int. Cl. F24F 3/14; B01D 53/26

(52) U.S. Cl. CPC F24F 3/1411; B01D 53/261

(57) ABSTRACT

A moisture absorber is provided having a container and a lid having a top surface and a bottom surface, the lid having an edge for attachment to the container, and a vapor transmission barrier attached to the bottom surface of the lid. A moisture absorber is provided comprising a container having a floor and at least one upstanding side wall from the floor of the container, the upstanding side wall having a lip and the container having at least one upstanding support extending upward from the floor of the container for supporting a removable tray having a plurality of openings; a lid having a top surface and a bottom surface, the lid having an edge for attachment to the lip of the upstanding side wall of the container; and a vapor transmission barrier attached to the bottom surface of the lid.

### CROSS-REFERENCE TO RELATED APPLICATION

This application claims priority from U.S. provisional patent application Ser. No. 62/484,950, filed on Apr. 13, 2017, in the United States Patent and Trademark Office. The disclosure of which is incorporated herein by reference in its entirety.

### FIELD OF THE INVENTION

The present invention relates to a spill resistant, refillable moisture absorber.

### BACKGROUND OF THE INVENTION

Atmospheric water vapor in high humidity environments can be problematic to personal articles, clothing for example, and other items which are susceptible to corrosion, mold, mildew, and other types of water related damage and deterioration. Also, the interior of vehicles, boats and airplanes that are subjected to wet and humid weather conditions can develop odors as well as mildew and mold, and can rot from constant exposure to humid air. Homes with poor sealing, especially in rainy climates are especially vulnerable to damage cause by humidity. Placement or positioning of a dehumidifying device can be a problem since the dehumidifying substances can cause damage or corrosion to the articles to be kept dry.

Spilling is a problem for most dehumidifying devices. Some dehumidifying devices address spill resistance by using tabs of moisture absorbent but this is expensive and often inefficient. Furthermore, many such dehumidifying devices are only useful for short periods of time. There is also a need to have the ability to refill such devices. Thus, there is a need for a moisture absorber that is both spill resistant and refillable.

### SUMMARY OF THE INVENTION

The present invention relates to a device that is a moisture absorber for removing atmospheric water vapor. A feature of the moisture absorber of the present invention is that it is spill resistant if tipped over and refillable.

In an embodiment of the invention, a moisture absorber is provided comprising a container having a floor and at least one upstanding side wall from the floor of the container; the upstanding side wall having a lip; a lid having a top surface and a bottom surface, the lid having an edge for attachment to the lip of the upstanding side wall of the container, and a vapor transmission barrier attached to the bottom surface of the lid.

In an embodiment of the invention, a moisture absorber is provided comprising a container having a floor and at least one upstanding side wall from the floor of the container, the upstanding side wall having a lip and the container optionally having at least one upstanding support extending upward from the floor of the container for supporting a removable tray having a plurality of openings; a lid having a top surface and a bottom surface, the lid having an edge for attachment to the lip of the upstanding side wall of the container; and a vapor transmission barrier attached to the bottom surface of the lid.

In an embodiment of the invention, the moisture absorber has a vapor transmission barrier attached to the lid of the container. The lid is constructed so that it offers a surface for attachment of the barrier. The vapor transmission barrier is attached to the back or underside surface of the lid, preferably by either adhesive or heat. However, any method of attachment that is known to one of ordinary skill in the art may be used.

In an embodiment of the invention, the lid has at least one opening such as in a form of a hole or slot, preferably a plurality of openings, to provide venting and to allow air access to the vapor transmission barrier. The lid has an attachment mechanism, preferably in the form of a rim, that fits snap-tight or snug to the container.

In an embodiment of the invention, a first charge of moisture absorbent is stored within the moisture absorber in moisture resistant packaging until use.

As a feature of the invention, the moisture absorber is refillable with, for example, bulk crystals or tablets of moisture absorbent or pouch containing crystals or tablets.

As a feature of the invention, the moisture absorber is spill resistant if tipped over.

As a feature of the invention, the moisture absorber is preferably rectangular, but could be of any size and shape depending upon the area meant to effect.

Among the advantages of the moisture absorber of the present invention are low initial cost and refill cost, easy draining of brine, refillable with bulk crystals or pouch containing crystals, and spill resistant.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a perspective view of a moisture absorber of the present invention.

FIG. 2 is an exploded view of the moisture absorber of FIG. 1.

FIG. 3 is an isometric view of the lid of the moisture absorber of FIG. 2.

FIG. 4 is a top view of the lid of FIG. 3.

FIG. 5 is a side view of the lid of FIG. 3.

FIG. 6 is a bottom view of the lid of FIG. 3.

FIG. 7 illustrates Detail A of the lid of FIG. 6.

FIG. 8 illustrates Section View C-C of the lid of FIG. 6.

FIG. 9 illustrates Section View D-D of the lid of FIG. 6.

FIG. 10 illustrates Detail B of Section View D-D of the lid of FIG. 9.

FIG. 11A is a top view of the vapor transmission barrier of the moisture absorber of FIG. 2.

FIG. 11B is a bottom view of the vapor transmission barrier attached to the lid of FIG. 3.

FIG. 12 is an isometric view of the tray of the moisture absorber of FIG. 2.

FIG. 13 is a top view of the tray of FIG. 12.

FIG. 14 illustrates Detail A of the tray of FIG. 13.

FIG. 15 illustrates Section View B-B of the tray of FIG. 13.

FIG. 16 illustrates Detail B and Detail C of the tray of FIG. 13.

FIG. 17 is a side view of the tray of FIG. 12.

FIG. 18 illustrates Section View M-M of the tray of FIG. 17.

FIG. 19 is an isometric view of the container of the moisture absorber of FIG. 2.

FIG. 20 is a top view of the container of FIG. 19.

FIG. 21 illustrates Section View A-A of the container of FIG. 20.

FIG. 22 illustrates Section View B-B of the container of FIG. 20.

FIG. 23 is a side view of the container of FIG. 19.

FIG. 24 is an end view of the container of FIG. 19.

FIG. 25 is a perspective view of moisture absorber 200 with two conical supports.

FIG. 26 illustrates a top view of moisture absorber of FIG. 25 with lid removed. FIG. 26 illustrates a tray inserted in the container of the moisture absorber, with the tray comprising at least one divider.

FIG. 27 is a partially exploded view of FIG. 25 illustrating that the container contains two conical supports extending upward from a base.

FIG. 28 illustrates a bottom surface of lid with vapor barrier.

FIG. 29 illustrates the moisture absorber of FIG. 25 containing desiccant in a tray with a divider.

FIG. 30 is a perspective view of a moisture absorber without a tray in an embodiment of the present invention.

FIG. 31 is an illustration of the moisture absorber of FIG. 30 with lid removed.

FIG. 32 is an illustration of the moisture absorber of FIG. 30 with lid removed and containing a bag of desiccant.

FIG. 33 is a Section View of the moisture absorber of FIG. 30 that is cut in the direction of the length of the moisture absorber.

FIG. 34 is a Section View of the moisture absorber of FIG. 30 that is cut in the direction of the width of the moisture absorber.

FIG. 35 is a perspective view of a round-shaped moisture absorber of the present invention.

FIG. 36 is a top view of the round-shaped moisture absorber of FIG. 35.

FIG. 37 is a partial exploded view of the round-shaped moisture absorber of FIG. 35.

FIG. 38 is a perspective view of an irregular-shaped moisture absorber of the present invention.

FIG. 39 is a top view of the irregular-shaped moisture absorber of FIG. 38.

### DESCRIPTION OF THE PREFERRED EMBODIMENTS

The following description of the embodiments of the present invention is merely exemplary in nature and is in no way intended to limit the invention, its application, or uses. The present invention has broad potential application and utility, which is contemplated to be adaptable across a wide range of uses. The following description is provided herein solely by way of example for purposes of providing an enabling disclosure of the invention, but does not limit the scope or substance of the invention.

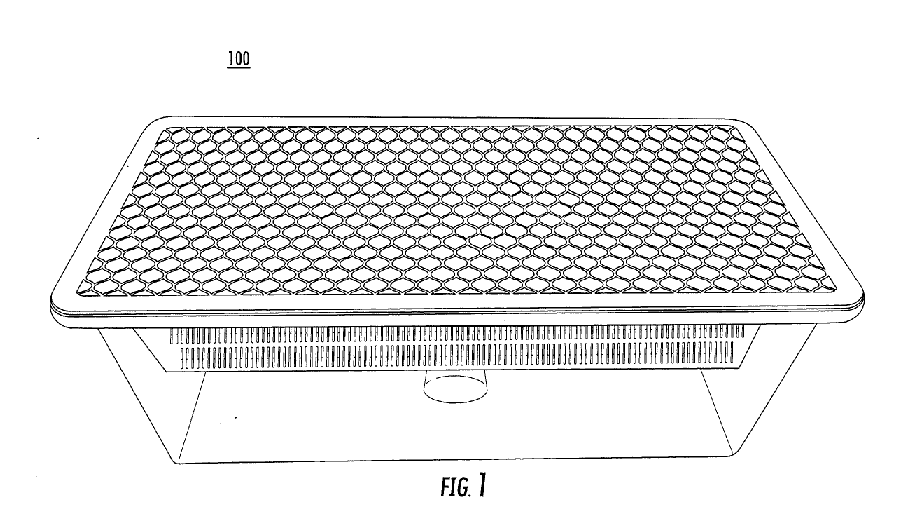

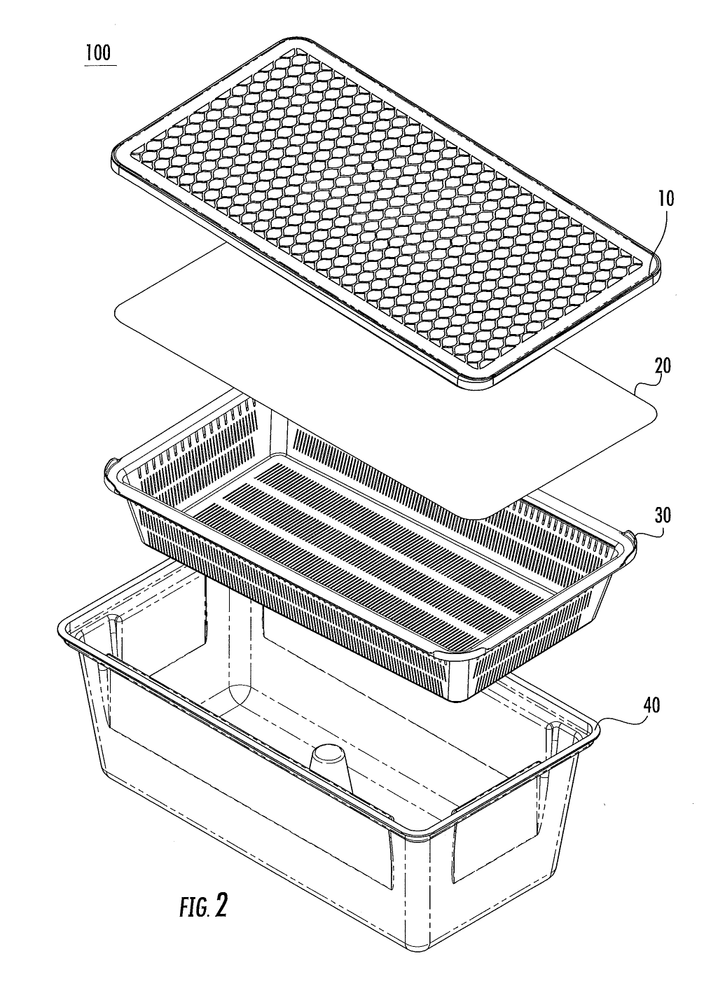

FIG. 1 is a perspective view of a moisture absorber 100 of the present invention. FIG. 2 is an exploded view of moisture absorber 100 of FIG. 1. Moisture absorber 100 generally comprises a lid 10, a vapor transmission barrier 20, a tray 30, and a container 40. Moisture absorber 100 can be of any size and dimensions.

The lid, the tray, and the container are each comprised of one or more polymeric materials. The polymeric material may be selected from the group consisting of polyethylene terephthalate (PET), high density polyethylene (HDPE), polyvinyl chloride (PVC), low density polyethylene (LDPE), polypropylene (PP), polystyrene (PS), and a combination thereof.

In an embodiment, moisture absorber 100 has an overall size of about 4 inches to about 34 inches in length, about 3 inches to about 34 inches in width, and about 1.5 to about 16 inches in height.

In another embodiment, moisture absorber 100 has an overall size of about 15 to about 17 inches in length, about 6 to about 9 inches in width, and about 4 inches to about 6 inches in height.

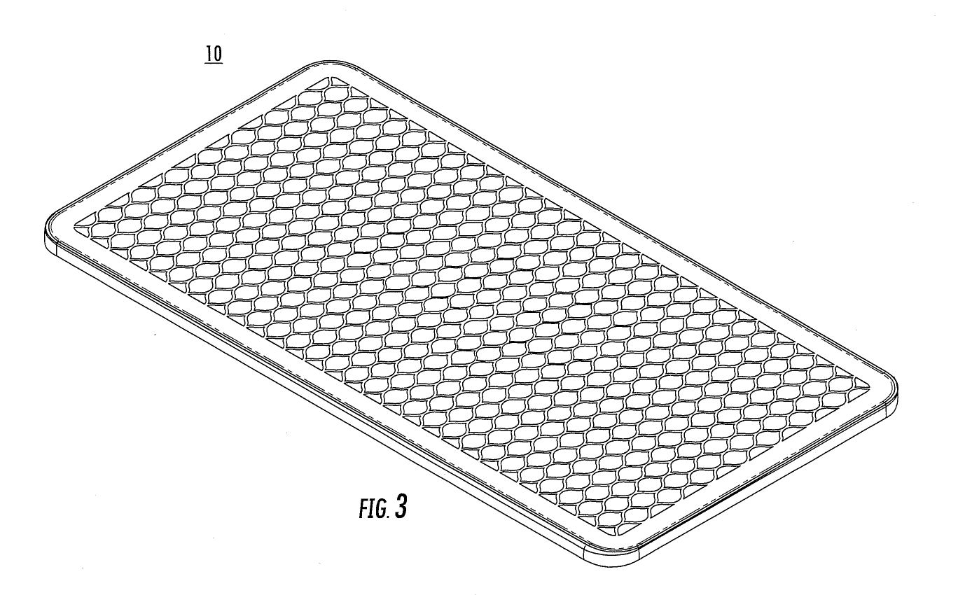

FIG. 3 is an isometric view of lid 10 of moisture absorber 100 of FIG. 2. FIG. 4 is a top view of lid 10 of FIG. 3. Lid 10 has a top surface 12 and a bottom surface 16. A downward curved rim 14 extends around the perimeter of lid 10. Lid 10 is attachable to a lip 44 (shown in FIG. 19) of container 40, and lid 10 is detachable from container 40.

FIG. 5 is a side view of lid 10 of FIG. 3.

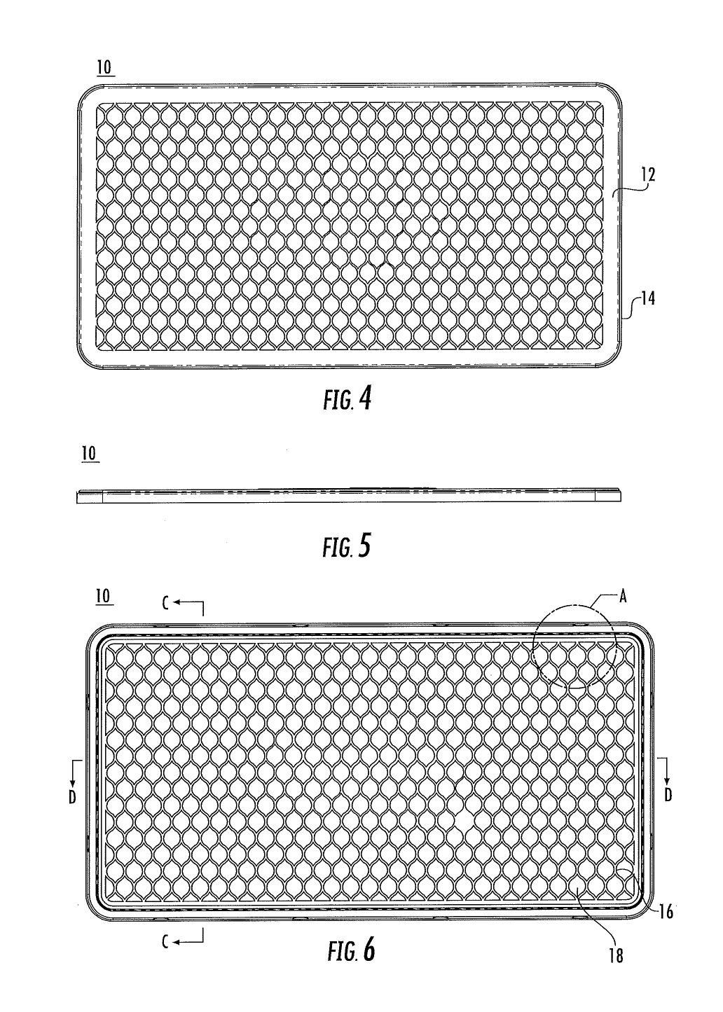

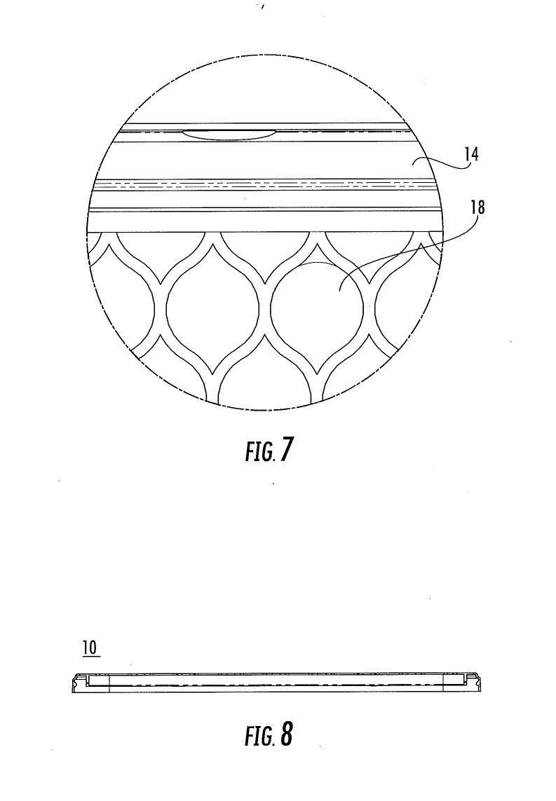

FIG. 6 is a bottom view of lid 10 of FIG. 3. Lid 10 comprises at least one opening of any shape or any dimension. FIG. 6 illustrates an opening 18, preferably a plurality of openings. Opening 18 may be in a repeating pattern. Opening 18 facilitates air flow. Lid 10 is preferably comprised of a polymeric material. The polymeric material of lid 10 is optionally reinforced in one or more locations. For example, lid 10 is optionally embossed with a logo. FIG. 7 illustrates Detail A of lid 10 of FIG. 6. In FIG. 7, an enlarged view of downward curved rim 14 and hole 18 is shown.

Lid 10 has vapor transmission barrier 20 affixed to lid 10 such as by welding, for example. This feature of lid 10 is advantageous as a consumer can reuse container 40 after a desiccant such as calcium chloride has turned into liquid brine.

Calcium chloride is a non-limiting example of a suitable moisture absorbent or chemical desiccant, but others are possible for use in the invention. The amount or size can vary widely based on the area in which the moisture absorber is to be used, the time frame needed, cost, and other factors. The area in which the moisture absorber is to be used and time until the moisture absorbent is used up can also be controlled or affected by the amount of vent area within the lid. Other additives that are optionally present include, but are not limited to, fragrance beads, starch, corn cob, fragrance, baking soda, carbon/charcoal, wood pulp, cellulose fibers, super-absorbent polymers (including, but not limited to, sodium polyacrylate, potassium acrylate, or alkyl acrylate), or a combination thereof.

Lid 10 creates a snap or snug-like fit with container 40, and water transmission barrier functions to control moisture the absorption rate of calcium chloride, but also functions to preventing splashing of calcium chloride crystals when transporting unit to different location or preventing sloshing of brine solution when carrying to be disposed of such as in a sink after completion of the desiccant.

FIG. 8 illustrates Section View C-C of lid 10 of FIG. 6.

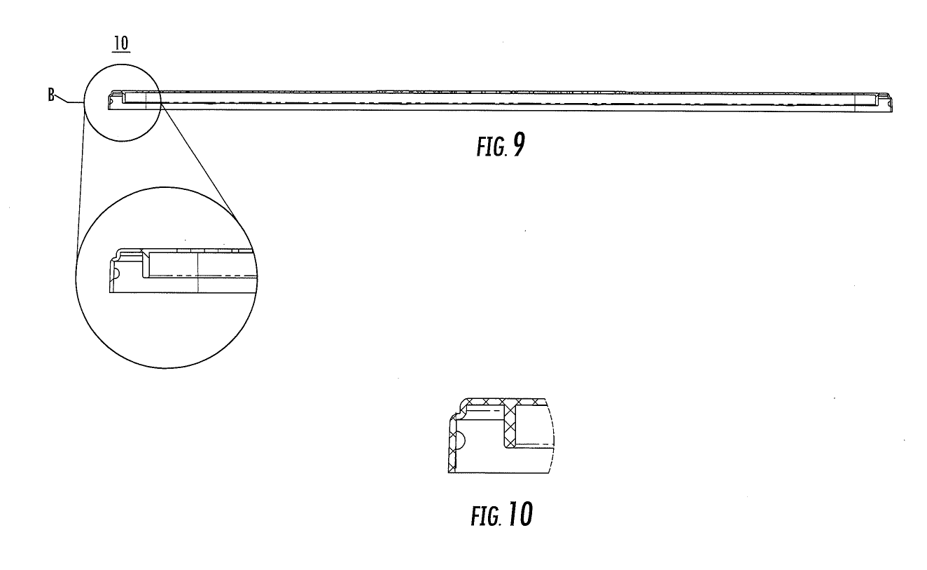

FIG. 9 illustrates Section View D-D of lid 10 of FIG. 6.

FIG. 10 illustrates Detail B of Section View D-D of lid 10 of FIG. 9.

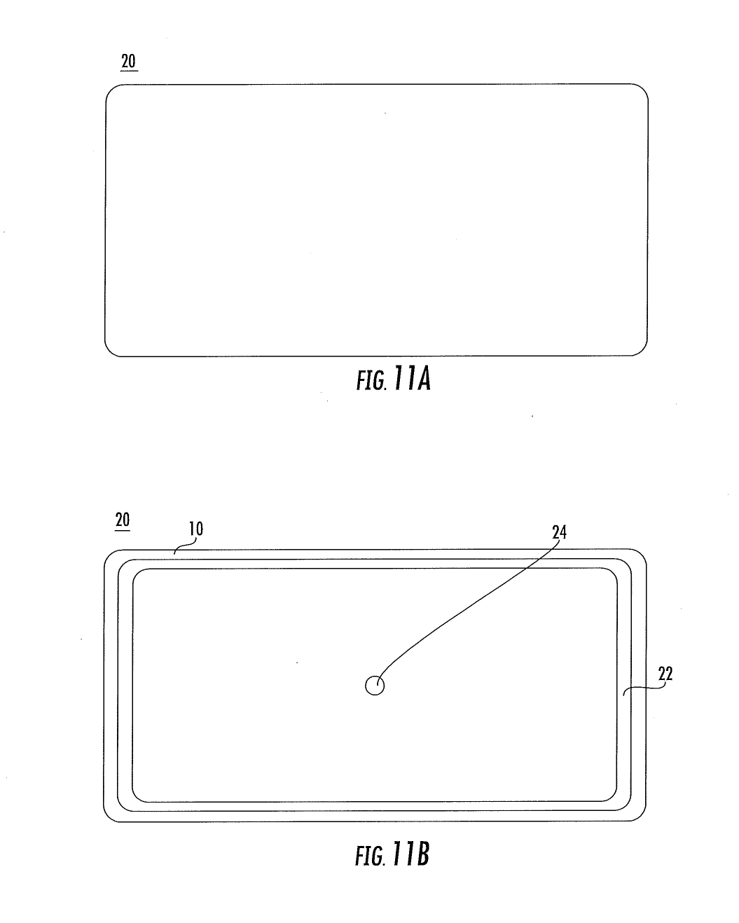

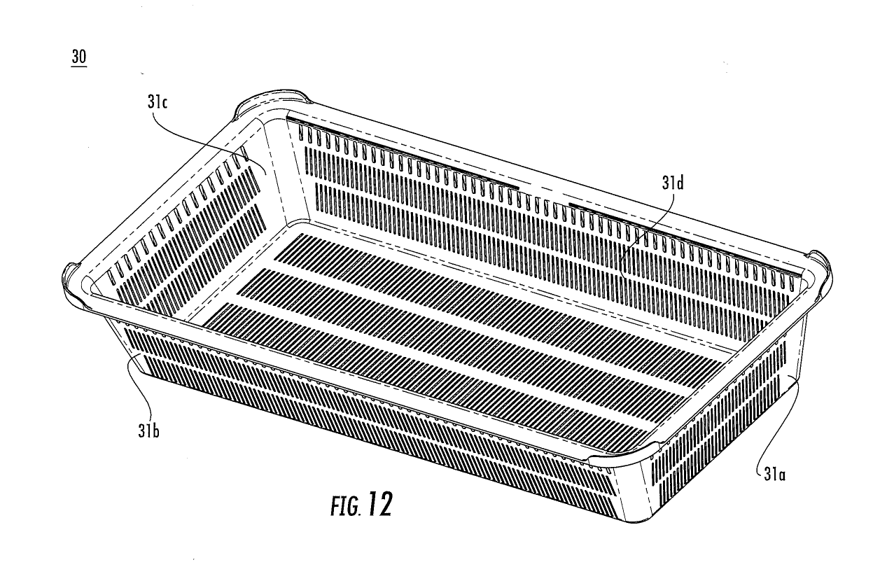

FIG. 11A is a top view of vapor transmission barrier 20 of moisture absorber 100 of FIG. 2. Lid 10 has vapor transmission barrier 20 attached to bottom surface 16 of lid 10, as shown in FIG. 11B. Preferably, vapor transmission barrier 20 is attached around the perimeter 22 of bottom surface 16 of lid 10 and at a secondary point of attachment 24, preferably in the middle, on bottom surface 16 of lid 10. Secondary point of attachment 24 provides additional support to prevent vapor transmission barrier 20 from sagging. Vapor transmission barrier 20 can be affixed or attached by an adhesive, welding, or any other method of attachment known to one of ordinary skill in the art. Non-limiting examples of materials of which vapor transmission barrier 20 is comprised include, but are not limited to, a non-woven sheet or laminate, a film, and a fabric. Vapor transmission barrier 20 is comprised of a natural or a synthetic material that is optionally treated with a coating to control vapor transmission. In a preferred embodiment of the invention, vapor transmission barrier 20 is spunbond olefin such as polyethylene. A non-limiting example of a commercially available spunbond polyethylene is Tyvek® RF from E. I. Du Pont De Nemours and Company. Preferably, vapor transmission barrier 20 covers the entirety of bottom surface 16 of lid 10.

FIG. 12 is an isometric view of tray 30 of moisture absorber 100 of FIG. 2. Tray 30 has four walls 31a, 31b, 31c and 31d. Each of walls 31a, 31b, 31c and 31d are preferably at an angle as shown in FIG. 12.

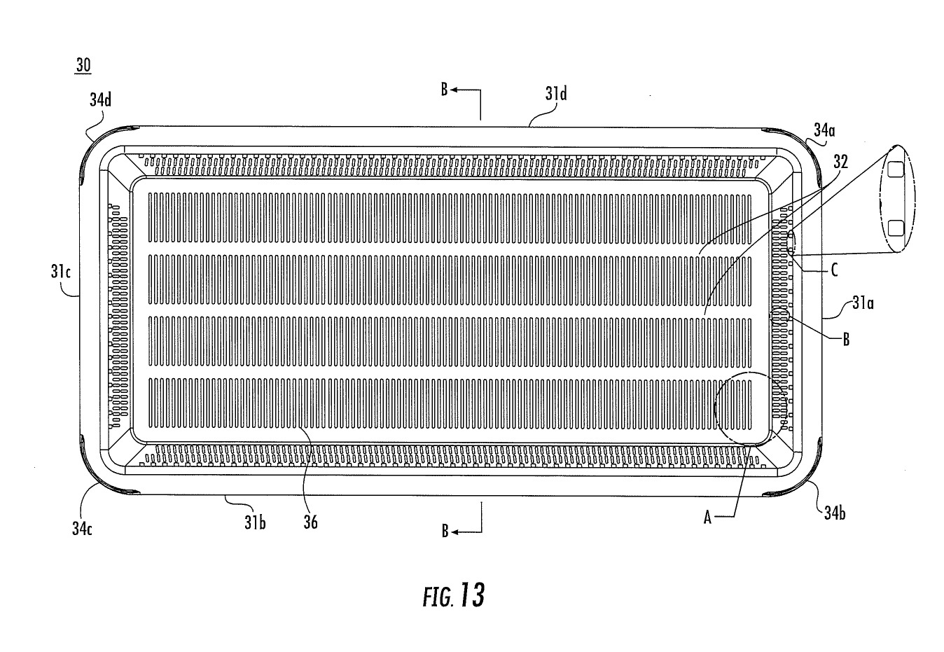

FIG. 13 is a top view of tray 30 of FIG. 12. Tabs 34a, 34b, 34c and 34d are at each corner of tray 30.

Any number of substances can act as a desiccant or water absorber for use in the moisture absorber 100. A non-limiting example of such substance is calcium chloride. Calcium chloride is a salt produced from the mixture of calcium and chlorine. It has hygroscopic properties which means that it attracts water molecules. Tray 30 is configured to contain a desiccant (not shown) and optional additives such as fragrance beads. For example, a consumer can place 5 lb of calcium chloride in the tray.

Tray 30 has at least one reinforcing rib 32 lengthwise in tray 30. The reinforcing rib 30 provides support when tray 30 becomes heavy from its contents. Tray 30 is configured such that, after lid 10 is removed, tray 30 and container 40 can be tipped towards one of its four corners to deposit brine.

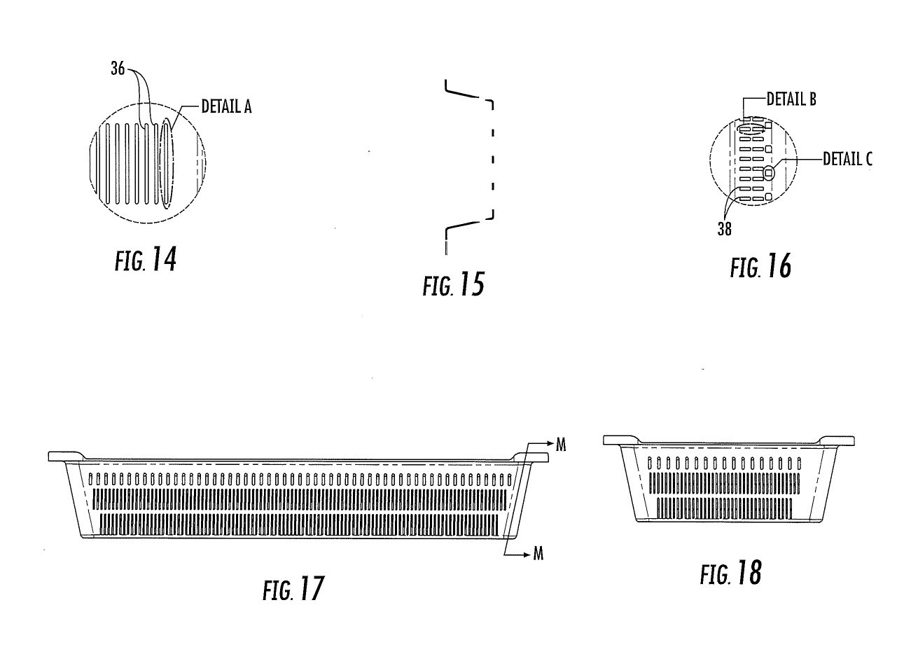

As shown in FIGS. 13 and 14, a plurality of open slots 36 run lengthwise from one end of tray 30 to the other end of tray 30. As shown in FIG. 13, there can be more than one row of open slots 36 that are separated by one or more reinforcing ribs 32. FIG. 14 illustrates Detail A of tray 30 of FIG. 13. A non-limiting example of the dimensions for slot 36 is 2.6 cm×0.04 cm. FIG. 14 illustrates Detail B of slot 38 (shown in FIG. 16) of tray 30. A non-limiting example of the dimensions for slot 38 is 1.2 cm×0.04 cm. FIG. 14 illustrates Detail C of tray 30 of FIG. 13. A non-limiting example of the dimensions for slot of Detail C of tray 30 is 0.5 cm×0.2 cm. Preferably, the width of a slot is in a range of about 0.04 cm to about 0.3 cm, more preferably about 0.1 cm to about 0.04 cm, and the height of slot 18 is in a range of about 0.2 cm to about 6 cm, more preferably about 0.3 cm to about 2 cm. FIG. 15 illustrates Section View B-B of tray 30 of FIG. 13.

As shown in FIG. 13, each of walls 31a, 31b, 31c and 31d has at least one row of open slots, preferably at least two rows of open slots having same length. Each of walls 31a, 31b, 31c and 31d preferably has a third row of open slots, more preferably of a different length than the first two rows. FIG. 16 illustrates Detail C of tray 30 of FIG. 13. FIG. 17 is a side view of tray 30 of FIG. 12. FIG. 18 illustrates Section View M-M at an end of tray 30 of FIG. 17.

Tray 30 is nestable meaning more than one tray can be stacked inside each other for shipment to a secondary location for assembling moisture absorber 100. Also at each corner of tray 30 are tabs 34a, 34b, 34c, and 34d, preferably slightly risen, configured such that a consumer can pull tray 30 out after the desiccant has turned completely to brine, so the brine can be poured out effortlessly.

Tray 30 preferably has three types of slots with different dimensions (Detail A, B, and C). The slots of Detail C are above the level to which calcium chloride is filled and are slightly wider in dimension as shown in Detail A and B. This is due to the phenomenon of calcium chloride hardening and expanding to be slightly larger in volume when it starts to absorb moisture. Icing can occur at a phase where the calcium chloride hardens so much that liquid water can build up on top of the moisture absorber. Larger holes above the original fill line allows drainage of this liquid water and compensates for the expansion of the calcium chloride. Narrower holes are used in Detail A as to prevent the calcium chloride flakes from falling through the tray when it is filled the first time by the consumer.

FIG. 19 is an isometric view of container 40 of moisture absorber 100 of FIG. 2. There is at least one conical support inside the container.

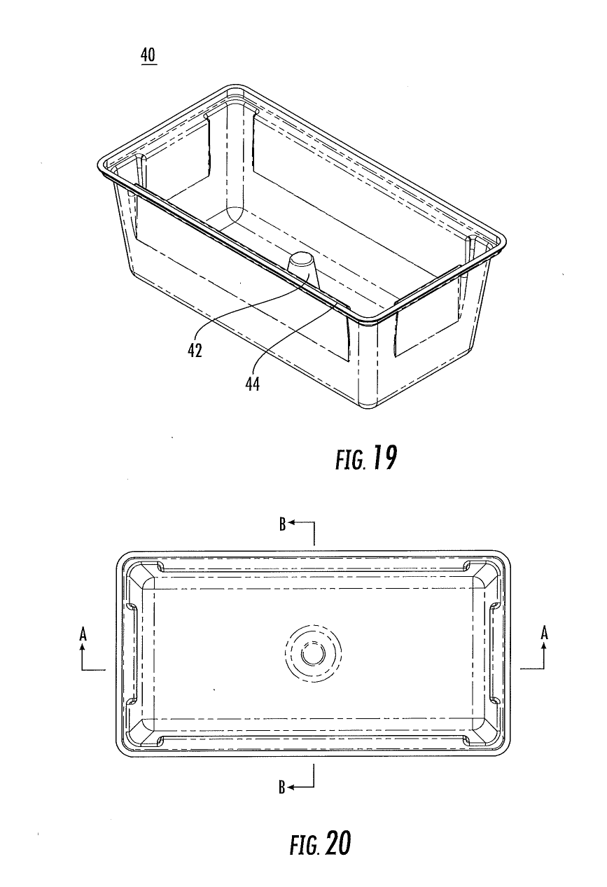

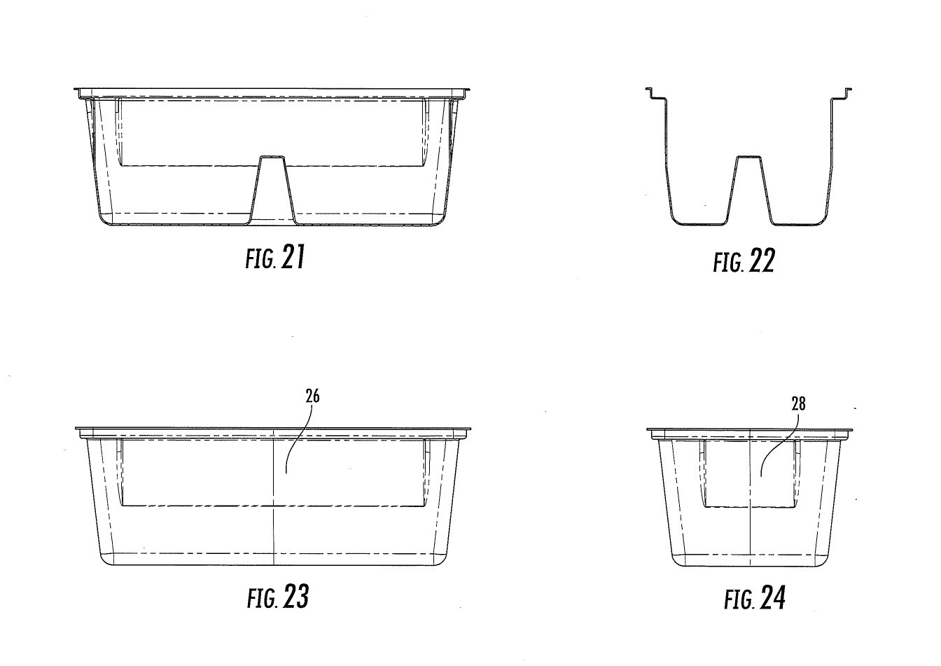

FIG. 20 is a top view of container 40 of FIG. 19. FIG. 21 illustrates Section View A-A of container 40 of FIG. 20. FIG. 22 illustrates Section View B-B of container 40 of FIG. 20. As shown in FIG. 19, as an optional feature, at least one pillar 42 is present. In the case of a single pillar or conical support, it is preferably in the middle of container 40 to support tray 30 inserted therein. Container 40 is nestable meaning many containers can be stacked inside each other for ease of shipment to a secondary location for assembling moisture absorber 100. In another embodiment of the invention, multiple pillars 42 are present in container 40.

In an embodiment of the invention, moisture absorber 100 further comprises a desiccant. For example, moisture absorber 100 may comprise at least one bag or container of calcium chloride (not shown). The unopened bags or containers may be present in the bottom of container 40 or tray 30. A consumer can pour these bags or containers into tray 30 to initiate use.

FIG. 23 is a side view of container 40 of FIG. 19.

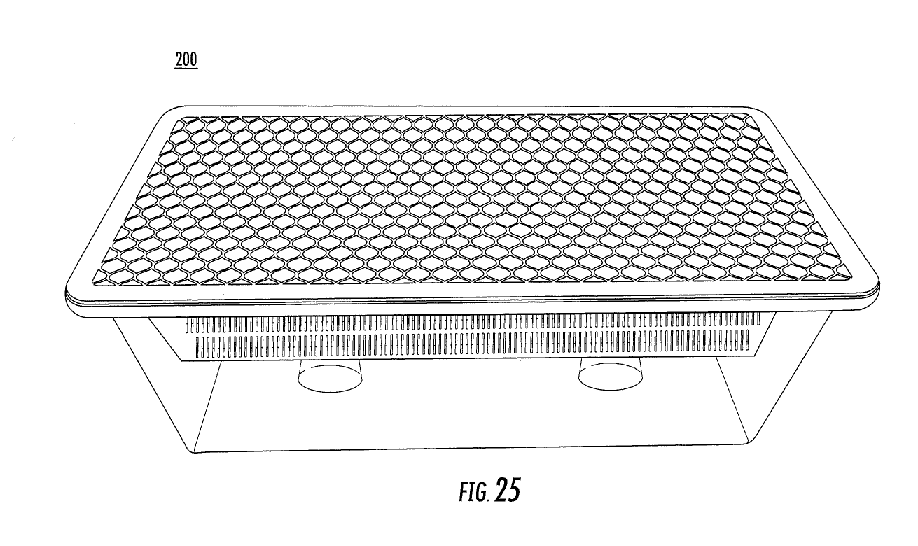

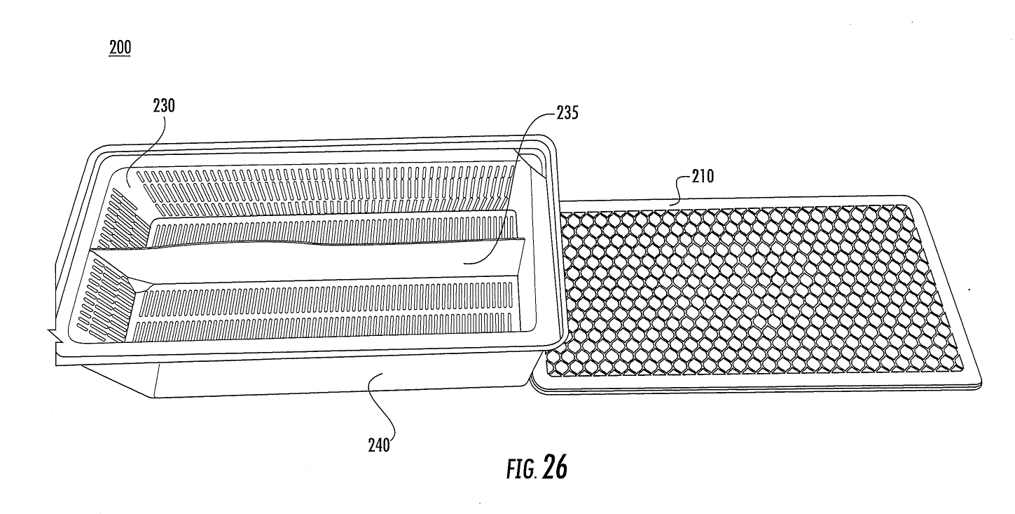

FIG. 24 is an end view of container 40 of FIG. 19.

As shown in FIGS. 23 and 24, respectively, flat sides 26 in shape of rectangles formed on sides of container 40 and flat sides 28 in shape of squares on sides (at ends) of container 40 allow for application of a label(s). Container 40 is preferably comprised of a transparent plastic material. Transparent plastic material allows consumer to see desiccant and solid white calcium chloride (top in tray 30) as it turns into liquid brine (in bottom of container 40).

Container 40 collects liquid brine after the calcium chloride reacts with moisture in the atmosphere.

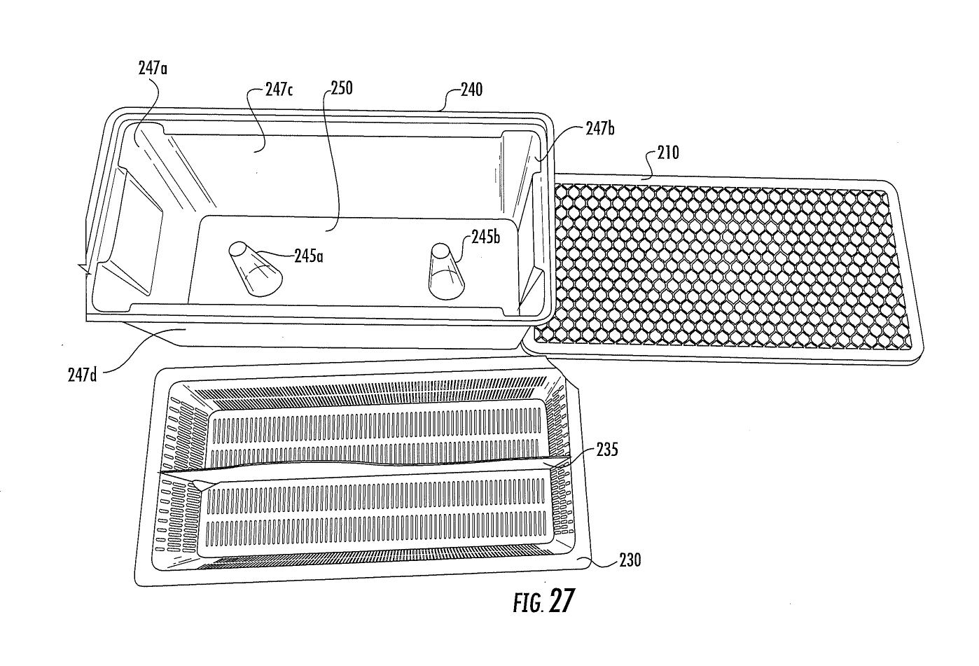

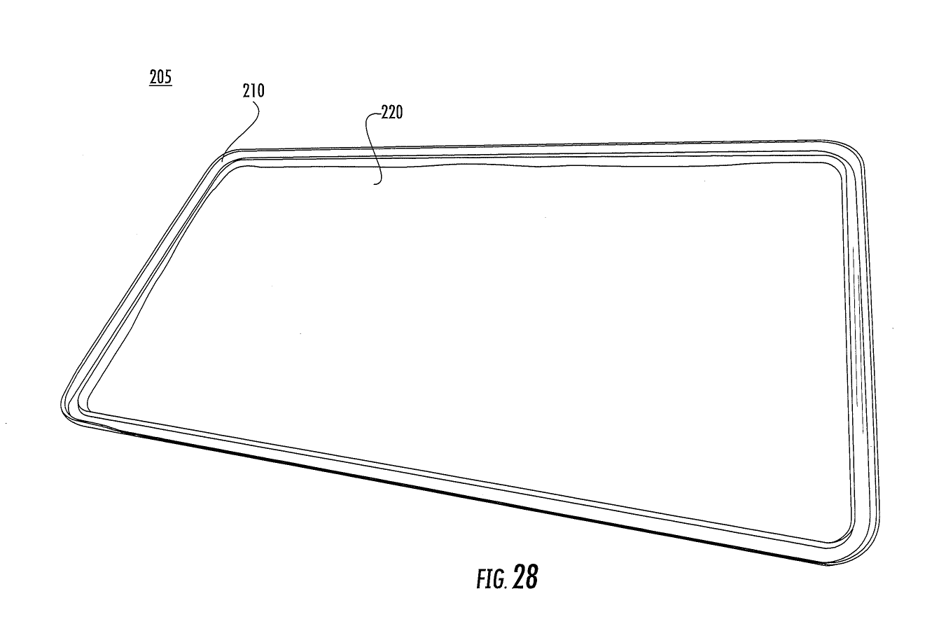

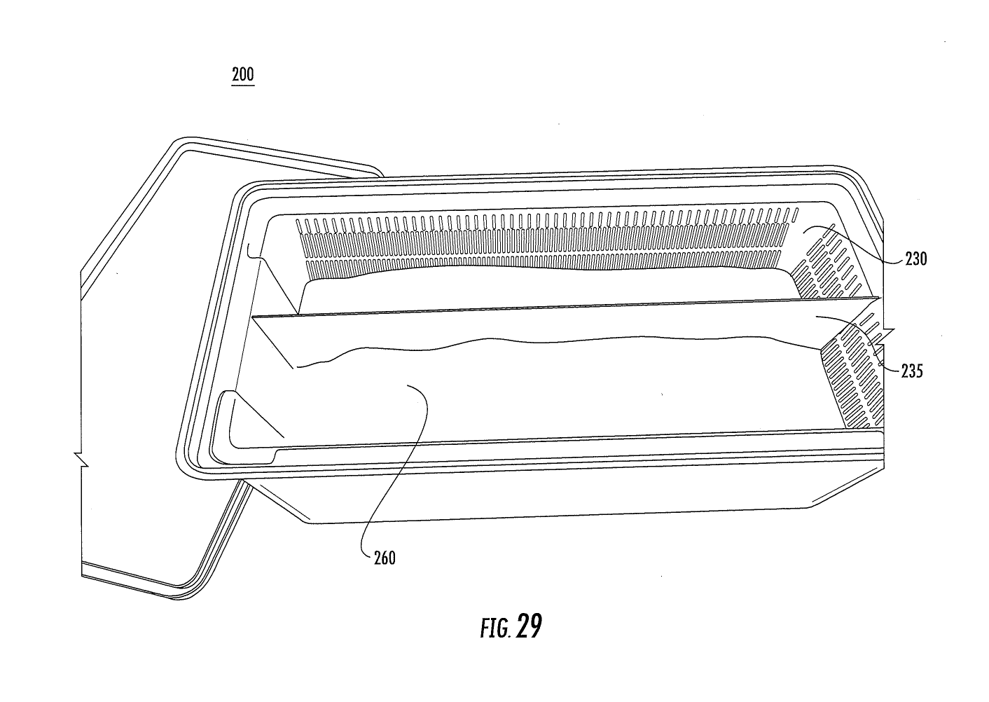

FIG. 25 is a perspective view of a moisture absorber 200. FIG. 26 illustrates a top view of moisture absorber 200 of FIG. 25 with lid 210 removed. FIG. 26 illustrates tray 230 inserted in container 240. Tray 230 comprises at least one divider 235. The at least one divider may run lengthwise, widthwise, or a combination thereof. FIG. 27 is a partially exploded view of FIG. 25 with tray 230 removed. Container 240 contains four sidewalls 247a, 247b, 247c, and 247d and two conical supports 245a and 245b extending upward from a floor 250 of container 240.

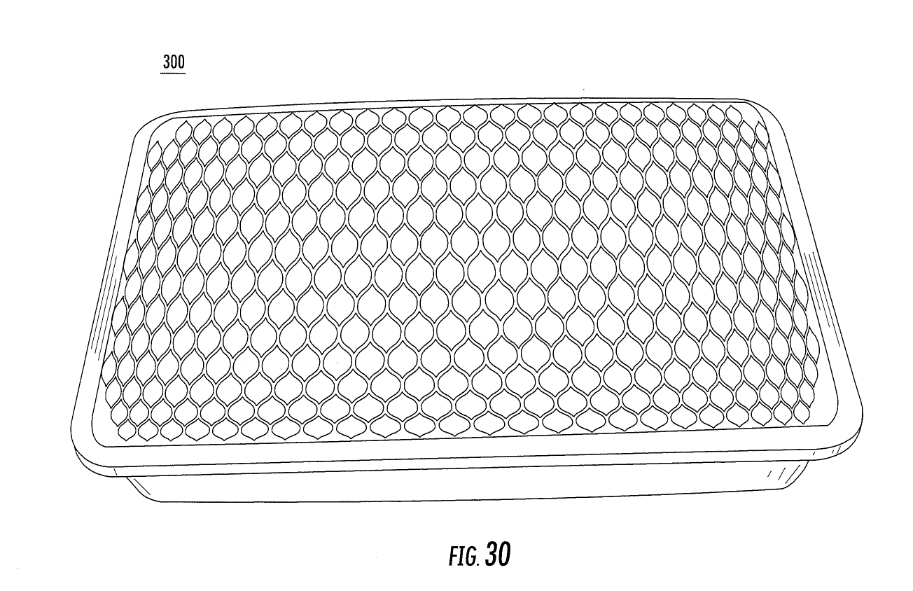

FIG. 28 illustrates bottom surface 220 of lid 210 with vapor barrier 220.

FIG. 29 illustrates the moisture absorber of FIG. 25 containing desiccant 260 in tray 230 with divider 235. One or more dividers may be present in tray 230.

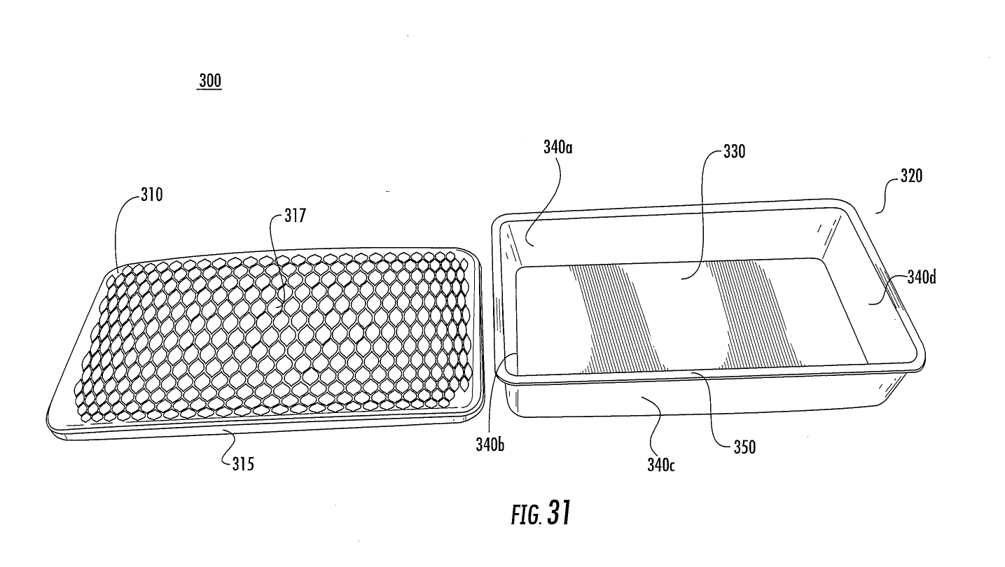

In an embodiment of the invention, a moisture absorber without a tray is provided. FIG. 30 is a perspective view of a moisture absorber 300 without tray.

Moisture absorber 300 can have any overall size, shape, and dimensions. Preferably, moisture absorber 300 is rectangular or square. Preferably, moisture absorber 300 has an overall size of about 4 inches to about 12 inches in width, about 4 inches to about 12 inches in length, and about one inch to about 6 inches in height.

FIG. 31 is an illustration of moisture absorber 300 of FIG. 30 with lid 310 removed. Moisture absorber 300 comprises a container 320 having a floor 330 and four upstanding side walls 340a, 340b, 340c, and 340d from floor 330 of container 320. Upstanding side walls 340a, 340b, 340c, and 340d having a lip 350 running around the perimeter of the side walls. Lid 310 has an edge 315 for attachment to lip 350 of the upstanding side walls of container 320. A vapor transmission barrier (not shown in FIG. 31) is optionally attached to the bottom surface/underside of lid 310. Lid 310 comprises at least one opening 317, preferably a plurality of openings. Lid 310 is preferably raised or domed in shape. The container may optionally comprise feet on the bottom to aid in securing the container to a surface upon which it rests. The lid and the container are each comprised of one or more polymeric materials. The polymeric material may be selected from the group consisting of polyethylene terephthalate (PET), high density polyethylene (HDPE), polyvinyl chloride (PVC), low density polyethylene (LDPE), polypropylene (PP), polystyrene (PS), and a combination thereof.

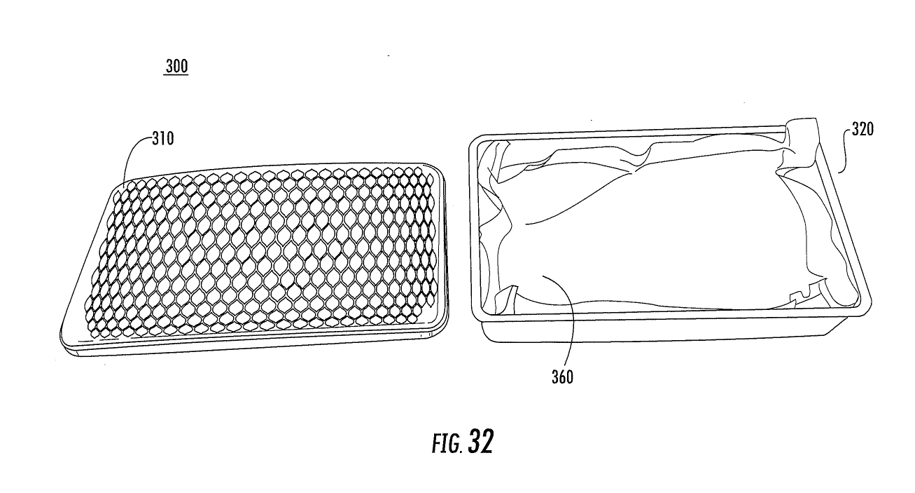

FIG. 32 is an illustration of moisture absorber 300 of FIG. 30 with lid 310 removed and container 320 containing an expandable bag or pouch of desiccant 360. The raised or domed lid of moisture absorber 300 allows for the expansion of expandable bag or pouch 360. Expandable pouch or bag 360 preferably is comprised, in whole or in part, of a natural or a synthetic material that is optionally treated with a coating to control vapor transmission. In a preferred embodiment of the invention, the material is a spunbond olefin such as polyethylene. A non-limiting example of a commercially available spunbond polyethylene is Tyvek RF from E. I. Du Pont De Nemours and Company. Expandable pouch or bag 360 is spill-proof. Brine is contained in the expandable pouch or bag, and it is disposable. Container 300 in combination with expandable pouch or bag 360 eliminates leak risk from the pouch or bag. Non-limiting examples of the contents of expandable pouch or bag 360 are calcium chloride (CaCl₂)), fragrance beads, starch, corn cob, fragrance, baking soda, carbon/charcoal, wood pulp, cellulose fibers, super-absorbent polymers (including, but not limited to, sodium polyacrylate, potassium acrylate, or alkyl acrylate), Carrageenan (GENU®), Xanthan Gum (Trade name Example KELZAN), Cellulose Gum/Carboxymethyl Cellulose, water-soluble polysaccharide (Gellan Gum), Pectin, Refined Locust Bean Gum, or a combination thereof.

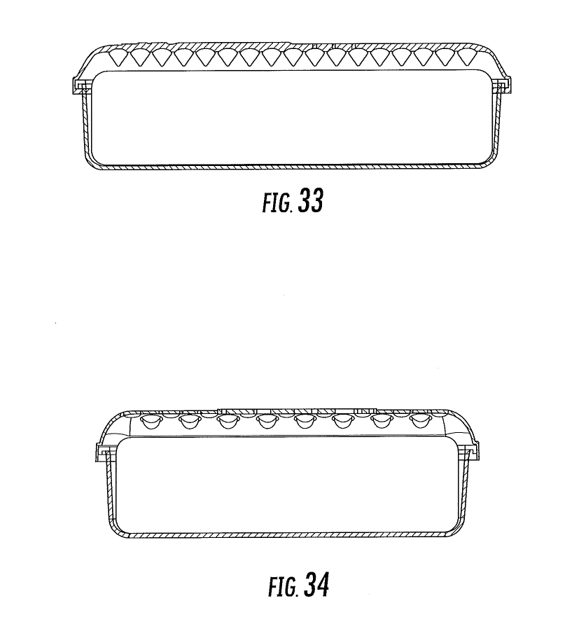

FIG. 33 is a Section View of moisture absorber 300 of FIG. 30 that is cut in the direction of the length of the moisture absorber.

FIG. 34 is a Section View of moisture absorber 300 of FIG. 30 that is cut in the direction of the width of the moisture absorber.

In an embodiment of the invention, the moisture absorber may be of any shape. For example, the moisture absorber may be rectangular, square, oval, circular, non-circular or irregular in shape

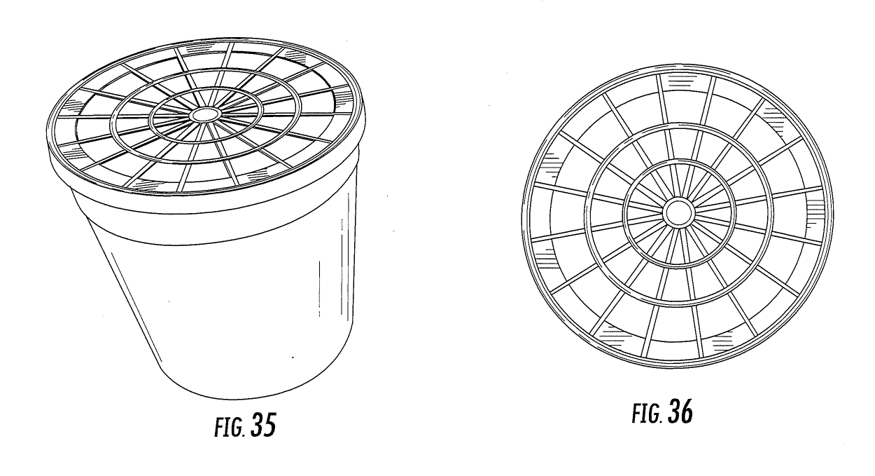

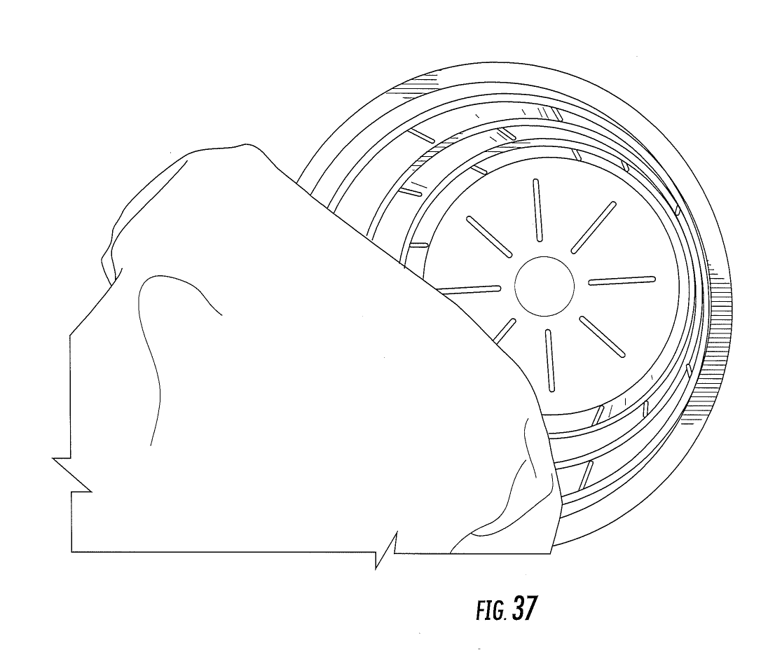

FIG. 35. illustrates a perspective view of a round-shaped moisture absorber. FIG. 36 is a top view of the round-shaped moisture absorber of FIG. 35. FIG. 37 is a partial exploded view of the round-shaped moisture absorber of FIG. 35.

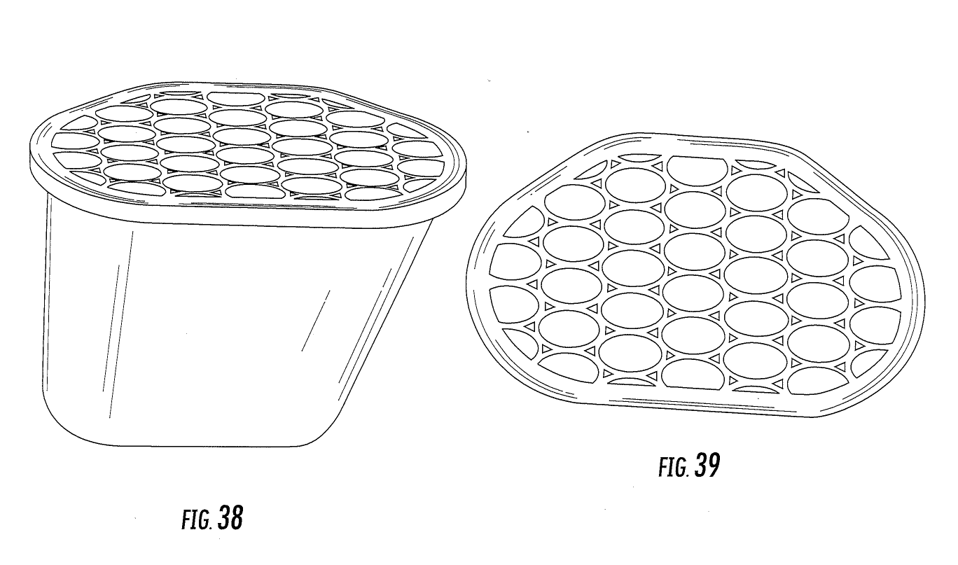

FIG. 38 illustrates a perspective view of an irregular-shaped moisture absorber. FIG. 39 is a top view of the irregular-shaped moisture absorber of FIG. 38.

In an embodiment of the invention, the moisture absorber may optionally comprise an indicator. The indicator is removable or permanent. The indicator is used for indicating and/or determining when it is time to replace the moisture absorbent or other additive. Non-limiting examples of an indicator are a sensor, sticker, color-change material, or other device.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A moisture absorber comprising:
a container having a floor and at least one upstanding side wall from the floor of the container, the upstanding side wall having a lip,
a lid having a top surface and a bottom surface, the lid having an edge for attachment to the lip of the upstanding side wall of the container, and
a vapor transmission barrier.

2. The moisture absorber according to claim 1, wherein the vapor transmission barrier is affixed to the bottom surface of the lid.

3. The moisture absorber according to claim 2, wherein the vapor transmission barrier is affixed to the lid by an adhesive or by welding.

4. The moisture absorber according to claim 1, wherein the vapor transmission barrier is in a form of a non-woven sheet, a laminate, a film, or a fabric.

5. The moisture absorber according to claim 1, wherein the vapor transmission barrier has a coating thereon to control moisture absorption.

6. The moisture absorber according to claim 1, wherein the vapor transmission barrier is a spunbond olefin.

7. The moisture absorber according to claim 1, wherein the container comprises an additive selected from the group consisting of a chemical dessicant, calcium chloride, fragrance beads, starch, corn cob, fragrance, baking soda, carbon, charcoal, wood pulp, cellulose fibers, super-absorbent polymer, carrageenan, xanthan gum, cellulose gum, carboxymethyl cellulose, water-soluble polysaccharide, gellan gum, pectin, refined locust bean gum, or a combination thereof.

8. The moisture absorber according to claim 7, wherein the additive is present in an expandable pouch or an expandable bag.

9. The moisture absorber according to claim 1, wherein the lid comprises at least one opening.

10. The moisture absorber according to claim 9, wherein the at least one opening is in a shape selected from the group consisting of a hole, a slot, and a combination thereof.

11. The moisture absorber according to claim 9, wherein the at least one opening is in a repeating pattern.

12. The moisture absorber according to claim 1, wherein the lid is raised or domed.

13. The moisture absorber according to claim 1, wherein the moisture absorber is 4 inches to 34 inches in length, 3 inches to 34 inches in width, and 1 inch to 16 inches in height.

14. The moisture absorber according to claim 1, wherein the moisture absorber is rectangular-shaped, round-shaped, or irregular-shaped.

15. The moisture absorber according to claim 1, wherein the moisture absorber comprises an indicator.

16. A moisture absorber comprising:
a container having a floor and at least one upstanding side wall from the floor of the container, the upstanding side wall having a lip and the container having at least one upstanding support extending upward from the floor of the container for supporting a removable tray having a plurality of openings,
a lid having a top surface and a bottom surface, the lid having an edge for attachment to the lip of the upstanding side wall of the container, and
a vapor transmission barrier attached to the bottom surface of the lid.

17. The moisture absorber according to claim 16, wherein the vapor transmission barrier is affixed to the lid by an adhesive or by welding.

18. The moisture absorber according to claim 16, wherein the vapor transmission barrier is in a form of a non-woven sheet, a laminate, a film, or a fabric.

19. The moisture absorber according to claim 16, wherein the vapor transmission barrier has a coating thereon to control moisture absorption.

20. The moisture absorber according to claim 16, wherein the vapor transmission barrier is a spunbond olefin.

21. The moisture absorber according to claim 16, wherein the container comprises a chemical dessicant.

22. The moisture absorber according to claim 16, wherein the container comprises an additive selected from the group consisting of calcium chloride, fragrance beads, starch, corn cob, fragrance, baking soda, carbon, charcoal, wood pulp, cellulose fibers, super-absorbent polymer, carrageenan, xanthan gum, cellulose gum, carboxymethyl cellulose, water-soluble polysaccharide, gellan gum, pectin, refined locust bean gum, or a combination thereof.

23. The moisture absorber according to claim 16, wherein the lid comprises at least one opening.

24. The moisture absorber according to claim 23, wherein the at least opening is in a shape selected from the group consisting of a hole, a slot, and a combination thereof.

25. The moisture absorber according to claim 23, wherein the at least one opening is in a repeating pattern.

26. The moisture absorber according to claim 16, wherein the moisture absorber is 4 inches to 34 inches in length, 3 inches to 34 inches in width, and 1 inch to 16 inches in height.

27. The moisture absorber according to claim 16, wherein the tray has at least one reinforcing rib.

28. The moisture absorber according to claim 16, wherein the tray comprises a plurality of open slots.

29. The moisture absorber according to claim 28, wherein the plurality of open slots comprises at least three open slots of varying size and dimension.

30. The moisture absorber according to claim 16, wherein the tray comprises at least one divider.

31. The moisture absorber according to claim 16, wherein the container, tray, or both are nestable.
